(19) United States
(12) Patent Application Publication
(10) Pub. No.: US 2012/0198355 A1
(43) Pub. Date: Aug. 2, 2012

(54) INTEGRATING MESSAGING WITH COLLABORATION TOOLS

(75) Inventors: Tessa A. LAU, Mountain View, CA (US); Jalal U. Mahmud, San Jose, CA (US); Tara L. Matthews, San Jose, CA (US); Thomas P. Moran, Portola Valley, CA (US); Barton A. Smith, Campbell, CA (US); Stephen J. Whittaker, Santa Cruz, CA (US)

(73) Assignee: International Business Machines Corporation, Armonk, NY (US)

(21) Appl. No.: 13/017,564

(22) Filed: Jan. 31, 2011

(51) Int. Cl. G06F 3/01; G06F 15/16

(52) U.S. Cl. 715/752

(57) ABSTRACT

Embodiments of the invention relate to integrating a messaging system with at least one collaboration tool. According to one embodiment of the invention, in response to a user creating a message in a messaging system, information from the message is compared with data sets associated with the user. Each of the data sets correspond to a collaboration topic of the user for the at least one collaboration tool. At least one of the data sets is selected based on the comparison, and information indicating the one or more collaboration topics of the user that correspond to the at least one data set that is selected is presented to the user via a user interface, with the information suggesting to the user to post the message to the one or more corresponding collaboration topics of the user.

### BACKGROUND

The present invention generally relates to collaboration tools, and more particularly relates to integrating messaging with collaboration tools.

People use various dedicated collaboration tools (e.g., wikis) to help them organize task materials in single location where all members can view these task materials. Various collaboration topics (e.g., a particular wiki) can be created in those tools to work on a particular aspect of the project. There are many different electronic collaboration tools that support collaborative tasks. Examples of collaboration tools are wikis (e.g., Mediawiki), teamrooms (e.g., Lotus Quickr), blogs (e.g., Blogspot), calendar meeting schedulers (e.g., Lotus Notes or Evite), forums (e.g., Ubuntu Forums and GameDev.net), groups (e.g., Yahoo Groups), activities (e.g., Lotus Activities), communities (e.g., Jive SBS), shared files (e.g., Google Documents, Microsoft Sharepoint, and Flickr), microblogs (e.g., Twitter and Yammer), and business processes (e.g., SalesForce.com).

### BRIEF SUMMARY

One embodiment of the present invention provides a method. According to the method, in response to a user creating a message in a messaging system, information from the message is compared with data sets associated with the user. Each of the data sets correspond to a collaboration topic of the user for the at least one collaboration tool. At least one of the data sets is selected based on the comparison, and information indicating the one or more collaboration topics of the user that correspond to the at least one data set that is selected is presented to the user via a user interface, with the information suggesting to the user to post the message to the one or more corresponding collaboration topics of the user.

Another embodiment of the present invention provides a computer program product comprising a computer readable storage medium having computer readable program code embodied therewith. The computer readable program code comprises computer readable program code configured to compare information from a message created by the user in a messaging system with data sets associated with the user that each correspond to a collaboration topic of the user for the at least one collaboration tool, select at least one of the data sets based on the comparison, and present information indicating the one or more collaboration topics of the user that correspond to the at least one data set that is selected, with the information suggesting to the user to post the message to the one or more corresponding collaboration topics of the user.

A further embodiment of the present invention provides a system that includes a matcher and a suggestion agent. The matcher compares information from a message created by the user in a messaging system with data sets associated with the user, and selects at least one of the data sets based on the comparison. Each of the data sets corresponds to a collaboration topic of the user for the at least one collaboration tool. The suggestion agent presents to the user via a user interface information indicating the one or more collaboration topics of the user that correspond to the at least one data set that is selected, with the information suggesting to the user to post the message to the one or more corresponding collaboration topics of the user.

Other objects, features, and advantages of the present invention will become apparent from the following detailed description. It should be understood, however, that the detailed description and specific examples, while indicating various embodiments of the present invention, are given by way of illustration only and various modifications may naturally be performed without deviating from the present invention.

### BRIEF DESCRIPTION OF THE SEVERAL VIEWS OF THE DRAWINGS

FIG. 1 is a block diagram illustrating an operating environment according to one embodiment of the present invention;

FIG. 2 is a block diagram illustrating a more detailed view of the operating environment of FIG. 1;

FIG. 3 illustrates the relationships between work units and collaborative topics according to one embodiment of the present invention;

FIG. 4 illustrates the relationships between work profiles, work units, and participants in a collaboration topic according to one embodiment of the present invention;

FIG. 5 shows an exemplary work unit according to one embodiment of the present invention;

FIG. 6 shows exemplary collaboration tools and their topics according to one embodiment of the present invention;

FIG. 7 shows a collaboration integration user interface according to one embodiment of the present invention;

FIG. 8 shows an exemplary collaboration topic after being updated with a message in accordance with one embodiment of the present invention;

FIG. 9 is a graph illustrating recall performance of an algorithm used in an embodiment of the present invention;

FIG. 10 is a graph illustrating precision performance of an algorithm used in an embodiment of the present invention;

FIG. 11 is an operational flow diagram for integrating messages with collaboration tools according to one embodiment of the present invention; and

FIG. 12 is a block diagram illustrating an information processing system applicable to embodiments of the present invention.

### DETAILED DESCRIPTION

Various embodiments of the present invention will be discussed in detail herein below with reference to the attached drawings.

It is now possible to collaborate with co-workers using many different enterprise collaboration tools (wikis, team spaces, and so on) to get work done. These tools offer benefits for collaboration, providing ways to create a shared space to organize work around tasks. The focus of the work may be thought of as a task, project, activity, etc., where the term “task” can refer to any kind of work focus. An electronic collaboration tool provides a way to share and organize task materials (digital information) in a shared electronic repository that is accessible to the people participating in the work, so that they can read, edit, organize, and manipulate the materials. The terms “collaboration tools” and “collaborative tools” are used herein to refer to tools that support shared materials. By this definition, email is not a collaborative tool, because there are no shared materials; each person has their own copy of the emails and attachments.

Web 2.0 technologies such as wikis, blogs, collaborative bookmarking, and social networking sites offer significant potential benefits for enterprise collaboration. However, one important property of these early systems is that they are generally focused on “weak tie” forms of collaboration where participation tends to be voluntary and participants may be unknown to each other at the outset. See, for example, M. Granovetter “The Strength of Weak Ties”, American Journal of Sociology, 78(6): 1360-1380, 1973. On the other hand, “strong tie” collaborations, where teams work together on focused projects such as wikis, forums, and blogs, offer potential additional benefits in allowing teams to share information. Wikis and forums, in particular, offer ways for teams to collate structure and manage collective team resources.

However, despite the potential benefits of tools such as wikis and dedicated collaborative applications such as Lotus Activities, considerable effort is required to shift to these tools. A team has to all agree on the tool that they want to use and there may be start up costs associated with this. Teams also have to negotiate collective practices for using collective resources, and research shows that new users are often unwilling to edit work of others on a wiki or to publish content that they feel is unfinished.

As a result, people find it easier to simply send emails and attachments to each other. However, one problem with using email for collaborative tasks is that each person must manage their own copy of the task materials, and email clients are not particularly good at helping people manage a multiplicity of emails around different tasks. Specifically, people have difficulty collating materials related to a given task when these are spread across multiple messages, determining the context for a given message, and monitoring the state of complex tasks. In addition, emails remain in each individual's email inbox, and the task materials are not shared. Each individual must manage and organize their own copies of email messages and attachments, which usually never become integrated with existing collaboration tools.

Furthermore, email studies show that materials relating to collaborative tasks end up in multiple, often disjoint threads distributed throughout the overloaded inbox. As a result, users have to scroll through their inboxes or access project folders to identify relevant versions of attachments and comments relating to shared tasks. This makes it difficult to keep track of collaboration deliverables and contributions. Email also increases personal workload as every involved participant has to organize and upload personal versions of documents, slides, and spreadsheets in their own email and personal file systems. Overall, resources and conversations are hard to track and are not shared, and everyone has the overhead of managing resources in their personal information space.

Embodiments of the present invention bridge messaging tools (such as email) and collaboration tools. While team members often set up collaboration topics (e.g., a wiki or a discussion forum) in collaboration tools, they commonly forget or do not make the effort to use them, instead reverting to email. Embodiments of the present invention enhance existing messaging clients to provide suggestions about collaboration topics to which team members might forward (i.e., post) their emails. This reminds users about the existence of the relevant collaboration tools and simplifies the process of contributing to those tools.

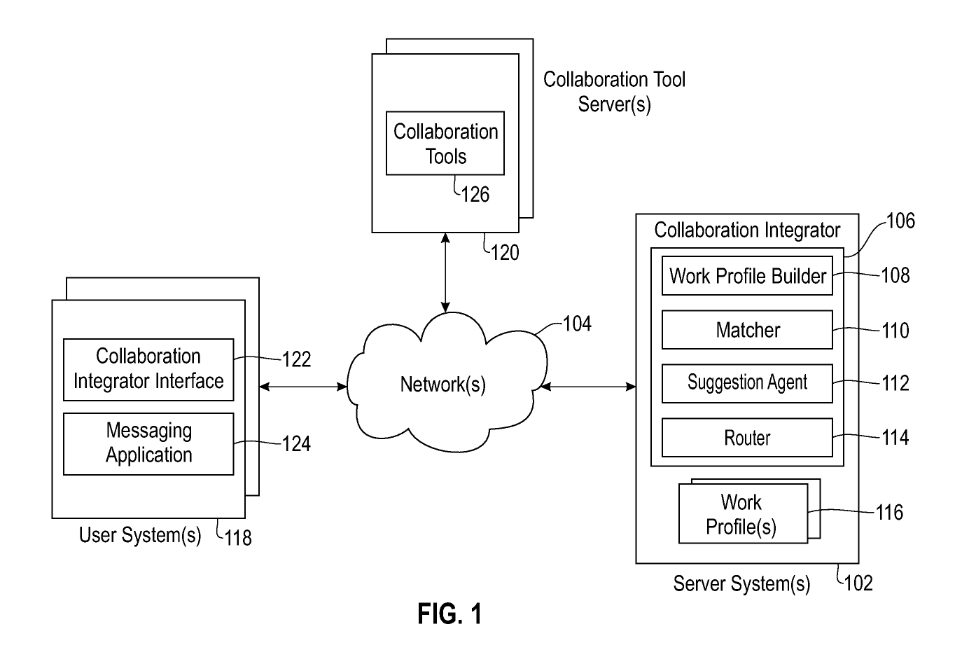

FIG. 1 illustrates an operating environment according to one embodiment of the present invention. The operating environment includes at least one system for integrating messages, such as emails, with collaboration tools. In particular, one or more server systems 102 are communicatively coupled to one or more networks 104. The network 104, in this embodiment, is a wide area networks, local area network, wired network, wireless network, and/or the like.

The server system 102, in this embodiment, comprises a collaboration integrator 106. The collaboration integrator 106, in this embodiment, comprises a work profile builder 108, a matcher 110, a suggestion agent 112, and a router 114. The collaboration integrator 106 integrates messaging (which is easier and more natural for users) with collaboration tools (which are explicitly designed to help users coordinate and manage tasks). The collaboration integrator 106 detects when a person is sending a message, such as an email, instant message, blog, and/or the like, determines, via the matcher 110, one or more collaborative tools that are potentially relevant to the message, and suggests, via the suggestion agent 112, these tools to the user. The collaboration integrator 106 then routes, via the router 114, the message to the tools that the user selected, in addition to sending the message to the users in the address fields of the message. Components of the collaboration integrator 106 can reside outside of the collaboration integrator 106 and/or across various systems.

The collaboration integrator 106 presents the user with suggestions on relevant collaboration tools by creating one or more work profiles 116 that index a person's collaborations and the tools involved. In this embodiment, the work profile 116 for each user is stored as a separate file on a server 102. Thus, users can engage in shared collaboration by simply sending messages to other users without having to learn and use dedicated collaboration tools. While an email message is used throughout this description as an exemplary message type applicable to the collaboration integrator 106, other types of messages, such as instant messages and blog messages, are applicable as well.

As shown in FIG. 1, one or more user systems 118 and collaboration tool servers 120 are also communicatively coupled to the network(s) 104. The user system(s) 118 is an information processing system such as a desktop computer, laptop computer, wireless device such as a mobile phone, personal digital assistant, or the like. The user system 118 comprises a collaboration integrator interface 122 and a messaging environment/application 124, such as an email application, an instant messaging application, a blogging application, or the like. In this embodiment, the collaboration integrator interface (user interface) 122 is embedded in a messaging client 124. However, in further embodiments the interface 122 resides outside of the messaging client 124. The collaboration interface 122 communicates with the collaboration integrator 106 so that the collaboration integrator 106 can detect when a user is sending a message via the messaging application 124, suggest collaboration tools to the user, and receive the user's selection from among the suggested tools. In this embodiment, the suggestion agent 112 resides within the collaboration integrator interface 122, while in further embodiments it resides outside of the collaboration integrator interface 122.

The collaboration tool server(s) 120 comprises collaboration environments/tools 126, such as wikis (e.g., Mediawiki), teamrooms (e.g., Lotus Quickr), blogs (e.g., Blogspot), calendar meeting schedulers (e.g., Lotus Notes or Evite), forums (e.g., Ubuntu Forums or GameDev.net), groups (e.g., Yahoo Groups), activities (e.g., Lotus Activities), communities (e.g., Jive SBS), shared files (e.g., Google Documents, Microsoft Sharepoint, or Flickr), microblogs (e.g., Twitter or Yammer), business processes (e.g., SalesForce.com), and so on. The users of the users systems 118 interact with these collaboration tools 126 to, among other things, organize task materials.

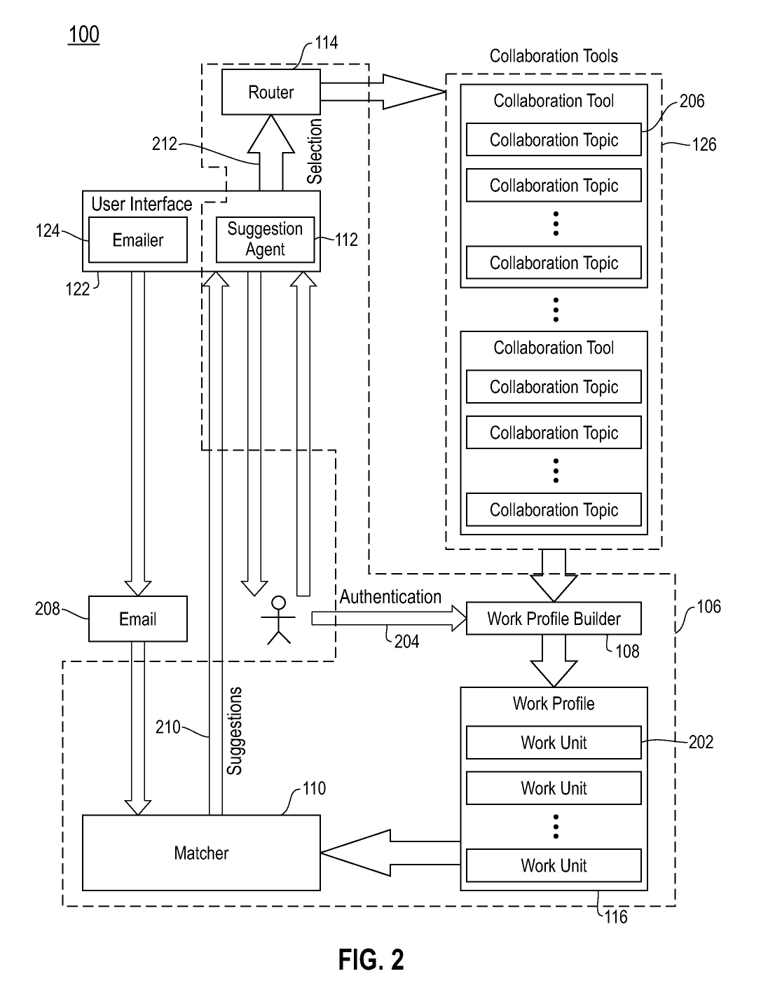

FIG. 2 shows the operating environment 100 of FIG. 1 in more detail. As shown in FIG. 2, the work profile 116 is a database of work units 202. Work units 202 are data structures or data sets that index and describe users' work foci such as projects, tasks, activities, etc. Users have particular foci for their work when they collaborate. The foci can be around objectives (e.g., planning an event), processes (e.g., purchasing approval), organizations (e.g., a department's monthly meeting), products (e.g., preparing a report), projects (e.g., developing software), and so on. There are a multitude of collaborative tools to support these different foci of work. Some tools are generic (e.g., wikis) and some are specialized (e.g., meeting schedulers). Some tools are formal (e.g., a work process application) and some are informal (e.g., Lotus Activities).

In this embodiment, a work unit 202 comprises a unique identifier, an optional title, a list of the users involved in a focus of work, a list of tags created by users or created automatically, a list of representative keywords that describe the content of the work focus, the status of the work (such as whether the work is currently active, completed, dormant, etc.), dates of activity for the work, a pointer to the collaborative tool used to support the work, pointers to related work units, email descriptors, and the like. An important aspect of the work unit 202 is the set of pointers to collaborative tools. Each collaborative tool supports collaboration topics 206 (also referred to as tool units, and The terms “tool unit” and “collaboration topic” are used interchangeably throughout this description).

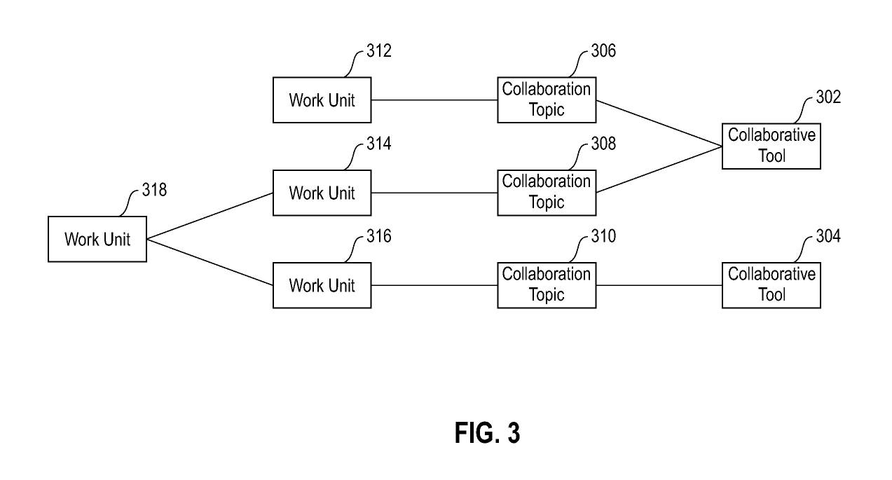

A collaboration topic 206 is a particular instance of data and processes. For example, a calendaring tool supports the creation of meetings. A particular meeting is a collaboration topic. For a wiki tool, a particular wiki site is a collaboration topic. For the Lotus Activities tool, a particular Activity is a collaboration topic. The exemplary diagram in FIG. 3 shows two collaborative tools 302 and 304. The first collaborative tool 302 has two collaboration topics 306 and 308 (these can be, for example, two files in a shared file tool), and the second collaborative tool 304 has one collaboration topic 310. The collaboration integrator 106, via the work profile builder 108, creates three work units 312, 314, and 316 that describe and point to these collaboration topics 306, 308, and 310. The collaboration topics 306, 308, and 310 contain the content of work and are what the users actually work with. The work units 312, 314, and 316 in the work profiles 116 serve as indices to these collaboration topics 306, 308, and 310. As shown in FIG. 3, work units can be related to other work units. For example, the work unit 318 is related to two other work units 314 and 316. This work unit 318 does not point to a tool unit directly, but it is related to tools indirectly through its related work units 314 and 316.

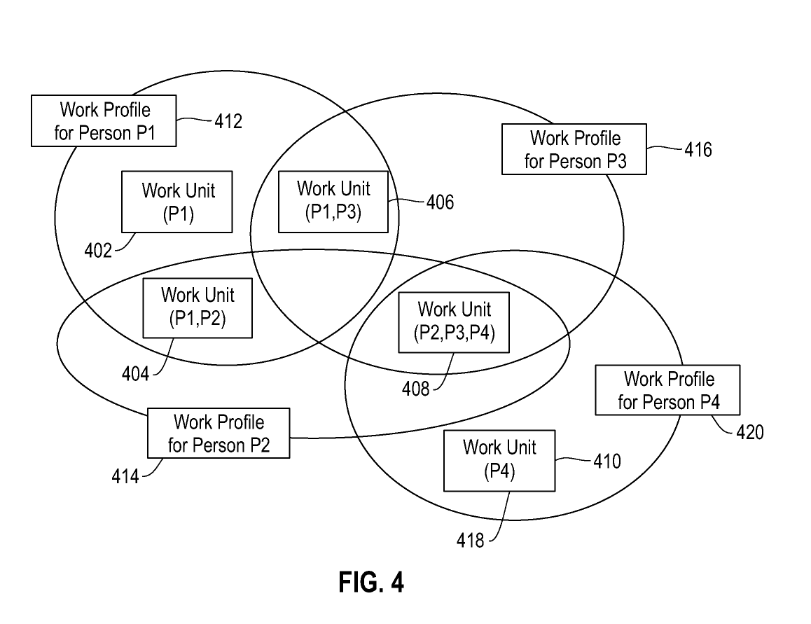

As explained above, the work profile 116 is a database of work units 202. Each work unit 202 describes the users involved in the work that the unit 202 represents. FIG. 4 shows five exemplary work units 402, 404, 406, 408, and 410, each involving a different user. Each user has a work profile comprising the work units that with which they are involved. For example, FIG. 4 shows work profiles 412, 414, 416, 418, and 420 for four different users. While each user's work profile is typically unique (a unique set of work units), each work unit in a user's work profile can be shared with other users, as shown in FIG. 4.

The work profile 116 is personalized (i.e., a separate work profile is built for each user). The work profile builder 108 uses a user's authentication information 204 (e.g., username and password in collaboration tools) to build that user's personalized work profile 116 by extracting their collaboration topics 206 from the collaboration tools 126. In this exemplary embodiment, the work profile builder 108 utilizes an application programming interface (API), such as the ATOM API, exposed by the collaboration tools to find these collaboration topics. The work profile builder also uses an API to retrieve a web feed for each collaboration topic, and then processes that feed and applies information retrieval algorithms to extract features from the collaboration topic.

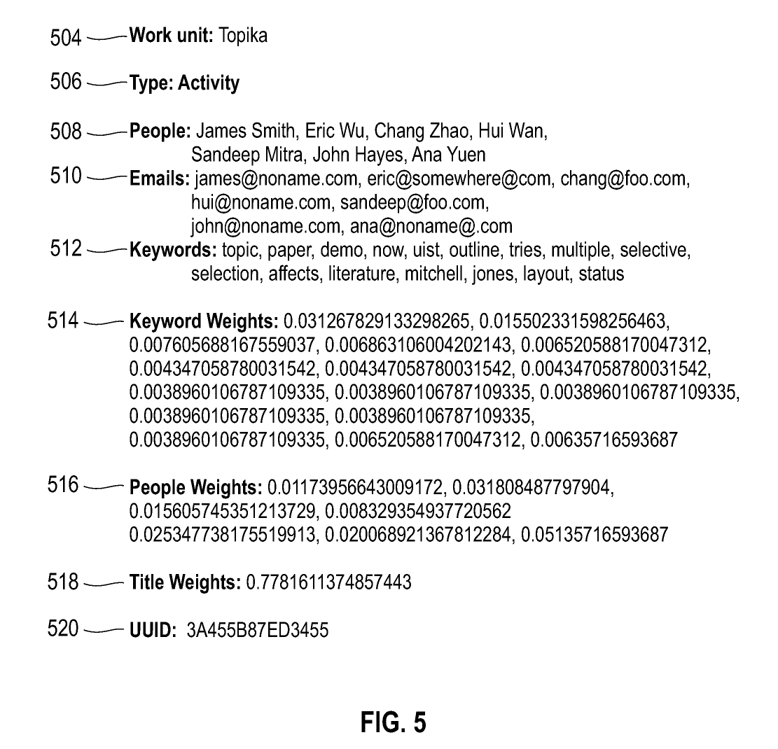

The work profile builder 116 creates a work unit 202 for each collaboration topic 206. FIG. 5 shows an exemplary work unit in a user's work profile. As shown in FIG. 5, the work unit 502 comprises a list of features, such as a Title 504 of the collaboration topic, a Type 506 of the collaboration tool (e.g., Activity, Wiki), People (i.e., users) 508 who are members of the collaboration topic, Email 510 addresses of the collaboration topic members, Keywords 512 collected from the collaboration topic contents, Weights 516 and 518 indicating the relevance of the title, people, and keywords in the work unit, and a UUID 520 that is the unique identifier of the collaboration topic. In this embodiment, an algorithm such as the algorithm described in Salton et al., “A vector space model for automatic indexing: (Comm. of the ACM, 18(11): 613-620, 1975), which is herein incorporated by reference in its entirety, is used to compute keyword weights, people weights, and title weights from keywords, people, and title words.

The work profile 116 for a set of users is built by mining the range of socio-collaboration tools that they use. The work profile builder 108, in this exemplary embodiment, interacts with one or more collaboration tools 126 associated with a given user to obtain the tool units/collaboration topics 206 associated with that user. Various mechanisms can be used by the work profile builder 108 to obtain the tool units/collaboration topics 206. For example, in one embodiment, the work profile builder 108 uses an API to obtain a web feed for each of the user's collaboration topics 206.

The work profile builder 108 then extracts summary information from each topic 206 and creates corresponding work units 202. The collaboration topic data in most collaborative tools 126 is accessible to only the users who are given access permission, which are usually the set of users involved in working with the collaboration topic 206. Therefore, the work profile 116, in this embodiment, is built on a per-user basis. In other words, each user who wants to be indexed in the work profile database gives the work profile builder 108 permission to access one or more collaboration topics 206 associated with that user, as shown by the authentication element 204 in FIG. 2.

Most of the data needed for work units 202 can be obtained directly from the collaboration topics 206. For example, for each collaboration topic, the work profile builder 108 extracts the names and email addresses of the users involved, the unique identifier (UUID) of the collaboration topic, and the title of the collaboration topic from the corresponding attribute values in the feed. The work profile builder 108 computes the weights for each of the names and the title words (after removing standard stop words) using an extraction algorithm such as the term frequency-inverse document frequency (TF-IDF) information extraction algorithm (see G. Salton et al. “A vector space model for automatic indexing”). In this embodiment, the corpus to compute IDF for the names is computed from all the names in that user's entire set of collaboration topics, and the corpus to compute IDF for the title words is computed from all the title words of that user's entire set of collaboration topics.

Although most of the data needed for the work units 202 can be retrieved from the collaboration topics 206, the set of keywords 512 summarizing the content of the collaboration topics 206 is computed. One technique for this keyword extraction is TF-IDF. However, other keyword extraction techniques can also be used. To generate collaboration topic content keywords, the work profile builder 108 first extracts all of the content words from that topic 206. The work profile builder 108 reads each of the entries, and store the words in a vector after eliminating stop words. Next, the work profile builder 108 computes the TF-IDF score of each of the words. To compute IDF, the work profile builder 108 maintains a corpus comprising the words from users entire set of collaboration topics 206. The work profile builder 108 selects the top N (N is set a priori) words as content keywords from the collaboration topic. As an example, the value of N (maximum number of keywords) can be set to 50, which works well in practice. However, other values of N can be used. Once the work profile builder 108 has computed the above features, the work profile builder 108 creates a work unit 202 for the collaboration topic 206 in the user's work profile 116, as shown in FIG. 5.

Collaboration topics 206 change dynamically over time. Therefore, the work profile 116 is updated as these changes are made. There are several ways that this updating can be performed. For example, in one embodiment each user allows the work profile builder 108 to periodically rebuild the work profile 116. In an alternative embodiment, the work profile 116 is updated by subscribing to feeds of changes from the collaborative tools 126, and the work profile builder 108 performs updates dynamically.

If the message type being integrated is an email message, in this embodiment a dynamic update is performed as follows. Whenever a user indicates that an email message is to be posted to a collaborative topic 206, a descriptor of that message is added to the corresponding work unit 202. Then, when another user creates a similar email message (e.g., the subject of the first email is “New idea” and the subsequent email subject is “RE: New idea”), posting to the same collaborative topic 206 is suggested.

Also, there are many systems that mine a user's email collection to compute that user's interests or social network (e.g., Lotus Atlas). Therefore, in one embodiment, one or more of these email mining systems is utilized to supplement a user's work profile 116. For example, if a user has email folders, these can be treated as collaborative topics 206 and work units 202 can be created for them. Email threads can also be treated as collaborative topic 206. Even further, email clusters derived by textual analysis can be considered as a “potential” collaborative topic 206. Potential collaborative topics 206 can be used to suggest to the user that they may want to create a new “real” collaborative topic 206 to share the material in the potential collaborative topic 206.

With respect to computing suggestions to display to the user via the interface 122, the matcher 110 matches the header and body information from the composed message 208 to the work profile 116 of the user and rates how relevant each work unit is to the message 208. Matching a message 208 to a work unit 202 is performed by computing different similarity values, such as the similarity between the set of users mentioned in the message 208 and the set of users in the work unit, the words in the body of the message 208 and the keywords in the work unit 202, the subject of the message 208 and the message descriptors in the work unit 202, and the current time and the times of activity in the work unit 202. In this embodiment, the overall similarity of a message to a work unit 202 is computed by combining these similarities. The set of work units 202 that are most similar to the message 208 are the prime candidates for the message to be associated with. The matcher 110 returns the top-K work units as relevant, where K can be set a priori. The matcher 110 uses a similarity function to compute the similarity value of each work unit with the message and then picks the top-scoring work units as relevant.

More specifically, there is a message such as an email E and a set of work units W={W₁, W₂, . . . Wₙ}. The similarity function Fₛ(E,Wᵢ) returns the similarity of work unit Wᵢ with email E. The matcher 110 applies this similarity function for each work unit Wᵢ in the set W, constructs a list of work units with their similarity values with the email, discards the work units which have no similarity (i.e., similarity value zero) with the email from the list, and returns the top-K (where K≦n) work units as relevant.

A discussion is now given on how the similarity function Fₛ(E,Wᵢ) is defined. A simple definition can be the cosine similarity (see G. Salton et al. “A vector space model for automatic indexing”) between the bag-of-words from the email and the work unit. However, such a simplified approach ignores the structure of the email (recipients, subject, and body) and the work unit (names, title, and keywords). Ignoring header data and using a simple bag-of-words can yield poor similarity scores for an email that does not have enough word-matches with the work unit. To illustrate this consider an email that has the following parts.
Recipients={james@foo.com}
Subject={Seminar}
Body={Let us organize this for next week after lunch. We have an excellent speaker. Her collaboration with the mobile research community is fantastic.}

The user's work profile has the following work units.

W₁:
Title={Seminar Series}
People={James, John, Harry}
Emails={james@foo.com, john@foo.com, harry@some.com}
Keywords={mobile, web, internet, iPad, iPhone}

W₂:
Title={Study Group}
People={John, Harry, Sam}
Emails={john@foo.com, harry@some.com, sam@foo.com}
Keywords={organize, collaboration, research, community, web, survey, cscw, study}

Assuming that K=1 (i.e., the user interface 122 displays only one suggestion to the user), in this example the cosine similarity matching between the email and the work units using the bag-of-words approach does not rate the work unit W₁ as most similar to the email. This is because W₁ has only a three word match (James, Seminar, mobile) with the email and the resultant cosine similarity score is lower than the cosine similarity score for the other work unit, which has a four word match (organize, collaboration, research, community) with the email.

However, in this example the first work unit should be suggested instead of the second one, because the title of the first (Seminar Series) closely matches the subject of the email (Seminar), and the single recipient of the email also matches one of the members of the work unit. An email's subject expresses the purpose of the email and is an important clue to find the relevancy of the email to the work units in a users' profile. Information in the subject line should therefore be rated more highly than regular content in the message body. Similarly, recipients of the email are also an important clue to find the relevancy of that email to a work unit. To use such important clues, people matching and title matching should be treated separately from keyword matching. For the above example, if title matching and people matching are considered separately and given higher weights, then work unit W₂ will have a lower matching score than W₁.

To incorporate this structured data, in this exemplary embodiment the similarity function Fₛ(E,Wᵢ) is defined as a weighted combination of the following similarity values.
s₁: Similarity between the set of people mentioned in the email and the set of people in the work unit.
s₂: Similarity between the subject of the email and the title of the work unit.
s₃: Similarity between the subject of the email and the keywords in the work unit.
s₄: Similarity between the words in the body of the email and the title of the work unit.
s₅: Similarity between the words in the body of the email and the keywords in the work unit.

Thus, Fₛ(E,Wᵢ)=w₁s₁+w₂s₂+w₃s₃+w₄s₄+w₅s₅. All of the above similarity values use cosine similarity values of two vectors. Vectors from different parts of the email are created to compute similarity values. If the email is denoted as Eᵢ, vectors are created from the “To”, “Subject”, and “Body” fields of the email. The first vector, denoted as vpᵢ, comprises the email addresses of the recipients typed in the “To” field. The second vector, denoted as vsᵢ, comprises the words in the subject field of the email, and the third vector, denoted as vbᵢ, contains the bag of words from the body of the email. For each work unit Wⱼ in a user's work profile, the vectors vpⱼ, vsⱼ, and vbⱼ are created. The first vector comprises the email addresses of the people in that work unit, the second vector comprises the words in the title of the work unit, and the third vector comprises the keywords of the work unit. Next, the similarity values are computed as follows.

s₁=cosine(vpᵢ,vpⱼ)

s₂=cosine(vsᵢ,vsⱼ)

s₃=cosine(vsᵢ, vbⱼ)

s₄=cosine(vbᵢ, vsⱼ)

s₅=cosine(vbᵢ, vbⱼ)

The cosine similarity computation uses the TF-IDF score of each term stored in the vector. For the vectors vpⱼ, vbⱼ and vsⱼ, a TF-IDF score is available from the work unit. However, for the vectors vpᵢ, vbᵢ and vsᵢ, the TF-IDF score of each term is determined by computing its TF in the email and normalizing by IDF, which is computed from the same corpus used to compute the IDF score of the terms in the work unit. Use of the same corpus ensures that words in emails and work units are normalized uniformly.

Similarity weights can also be learned from examples. In this embodiment, the similarity weights w₁, w₂, w₃, w₄ and w₅ are learned from a corpus of emails, work units, and user supplied relevancy labels. The corpus is generated by having users label their emails to indicate the relation between each email and their work units. If E={E₁, E₂, . . . } denotes a set of emails and W={W₁, W₂, . . . } is a set of work units in the corpus, this algorithm uses a user provided relevancy label to provide a mapping between each email Eᵢ and work unit Wⱼ in the corpus. These relevancy labels are denoted as U(Eᵢ, Wⱼ) where:

$$\begin{matrix}U ( {E}_{i} , {W}_{j} ) = 1 , & if {E}_{i} and {W}_{j} are said to be relevant by the user ; \\ = 0 , & otherwise .\end{matrix}$$

Thus, the input to this algorithm is the user provided relevancy labels between each email and work unit pair. Next, the relevancy between each email and work unit pair is computed using each of the similarity metrics. This is denoted as Sₖ(Eᵢ, Wⱼ) where:

$$\begin{matrix}{S}_{k} ( {E}_{i} {W}_{j} ) = 1 , & if {W}_{j} is suggested using the similarity metric {S}_{k} ; \\ = 0 , & otherwise .\end{matrix}$$

Next, for each of the similarity metrics, the user provided relevancy label (U(Eᵢ, Wⱼ)) and the relevancy label computed by the similarity metric Sₖ for each email and work unit pair are compared. The total number of agreements between them is counted. Table 1 illustrates this for emails {E₁, E₂, E₃} and work units {W₁, W₂, W₃, W₄}.

TABLE 1

| | W₁ | W₂ | W₃ | W₄ |
|---|---|---|---|---|
| E₁ | X Y | Y | X | |
| E₂ | | X Y | Y | |
| E₃ | X Y | X | | X Y |

In the table, X's show the relevancy relation that the user indicated between a message and a work unit and Y's indicate the relations that the algorithm computed. The cells which are blank are neither defined as relevant by users nor found to be relevant by the similarity metric Sₖ. Thus, there is an agreement between the algorithm and user when a given cell in the table comprises both an X and a Y (i.e., the user and the algorithm agree on a label), or when the cell is blank (i.e., the user and the algorithm agree that there is no match between that message and the work unit).

Aₖ(Eᵢ, Wⱼ) is the function defined as follows.

$$\begin{matrix}{A}_{k} ( {E}_{i} , {W}_{j} ) = 1 , & if {S}_{k} ( {E}_{i} , {W}_{j} ) \\ = U ( {E}_{i} , {W}_{j} ) & \\ = 0 , & otherwise\end{matrix}$$

Thus, Aₖ(Eᵢ, Wⱼ) measures the agreement between the user provided relevancy and the relevancy computed by the similarity metric Sₖ. Continuing with the example, Aₖ(E₁, W₁) is 1 because the email and work unit pair is said to be relevant by the user and also found as relevant by the similarity metric Sₖ. Similarly, Aₖ(E₂, W₂)=1, Aₖ(E₃, W₁)=1, and Aₖ(E₃, W₄)=1 because the corresponding email and work unit pair is said to be relevant by the user and computed as relevant by the algorithm. Aₖ(E₁, W₄)=1, Aₖ(E₂, W₁)=1, Aₖ(E₂, W₄)=1, and Aₖ(E₃, W₃)=1 because the user and algorithm agree that there is no match between the corresponding email and work unit.

All such agreements (where Aₖ(Eᵢ, Wⱼ)=1) between email and work unit pairs are counted. The resultant number is the agreement score Aₖ for the similarity metric Sₖ. Thus, in this example, the agreement score Aₖ is 8. Once the agreement score Aₖ is determined using the above algorithm for each similarity metric Sₖ, the agreement scores Aₖ are added to obtain the normalization factor A. The weight wₖ of the similarity metric Sₖ is computed as: wₖ=Aₖ/A. To illustrate this, if there are two similarity metrics s₁ and s₂ and the agreement scores computed for them are 2 and 3, then w₁=⅖ and w₂=⅗.

Once the suggestions have been determined using the above process, the collaboration integrator suggestion agent 112 presents these suggestions 210 to the user via the collaboration integration interface 122. In this embodiment, the email client has a “Post” field, as well as “To” and “CC” fields, that hold the names of the tool units/collaboration topics 206 that the email is going to be routed to. The modified client also comprises an area to display suggested relevant work units 202 and a mechanism that allows the user to make a selection 212 with respect to one or more displayed work units 202. The collaboration integration interface 122 can be embedded in a plug-in for the messaging client 124. Alternatively, the collaboration integration interface 122 can be a desktop application on the user's system 118 or a web service that is displayed in a web browser.

The weights of each similarity metric can be dynamically updated depending on each user's collaboration pattern (which may change over time). Also, there can be situations in which messages are automatically posted to collaboration topics 206 without interacting with the user. In this case, the collaboration integration interface 122 may not be used, or there may be a minimal collaboration integration interface 122 that informs the user when an automatic posting occurs. Also, the collaboration integration interface 122 can be used to allow a person to view their work profile 116. The collaboration integration interface 122 can allow the person to edit the work units 202, adding or correcting the automatically mined information (e.g., add or change keywords), changing the status of work units (e.g., a particular wiki is an obsolete version), relating work units (e.g., relating a particular wiki and a particular Activity as a higher level work unit, as shown in FIG. 2), and so on.

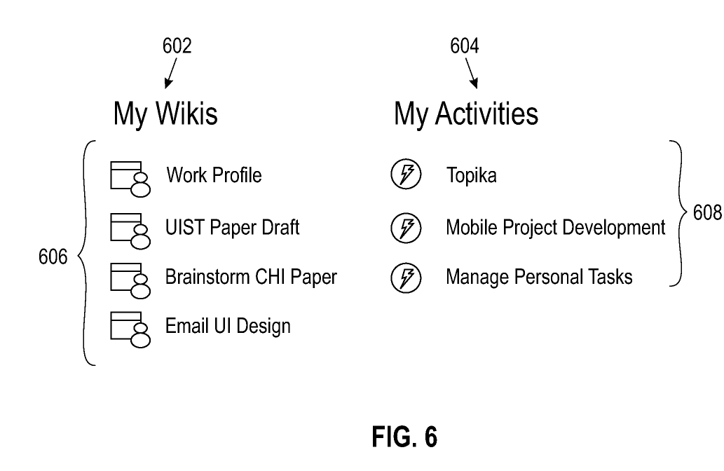

FIGS. 6-8 show examples of the collaboration integration interface being integrated with a messaging client according to one embodiment of the present invention. Consider a user named Ana who is a knowledge worker that utilizes the collaboration integration system of FIGS. 1 and 2 to collaborate with her colleagues when using collaboration tools 126. In the past, Ana and her colleagues have used activities and wikis to collaborate on a number of projects. FIG. 6 shows an example of her wikis 602 and her activities 604. Each set of wikis 606 and each set of activities 608 is a collaboration topic 206 on which Ana participates with her colleagues. As Ana is sending a message 208 using the messaging client 124, the collaboration integrator 106 suggests from this pool of wikis 606 and activities 608 (i.e., collaboration topics) where to post her message. To obtain these suggestions, Ana initializes the collaboration integrator 106 by using the work profile builder 108 to automatically build her work profile 116 from her collaboration topics 606 and 608 in the wikis tools 602 and activities 604. Of course, if the work profile 116 already exists for Ana, then this step is not performed. The work profile 116 comprises a work unit 202 for each of her collaboration topics 606 and 608. Each work unit comprises a set of features (e.g., keywords and people) relevant to the collaboration topic, as explained above.

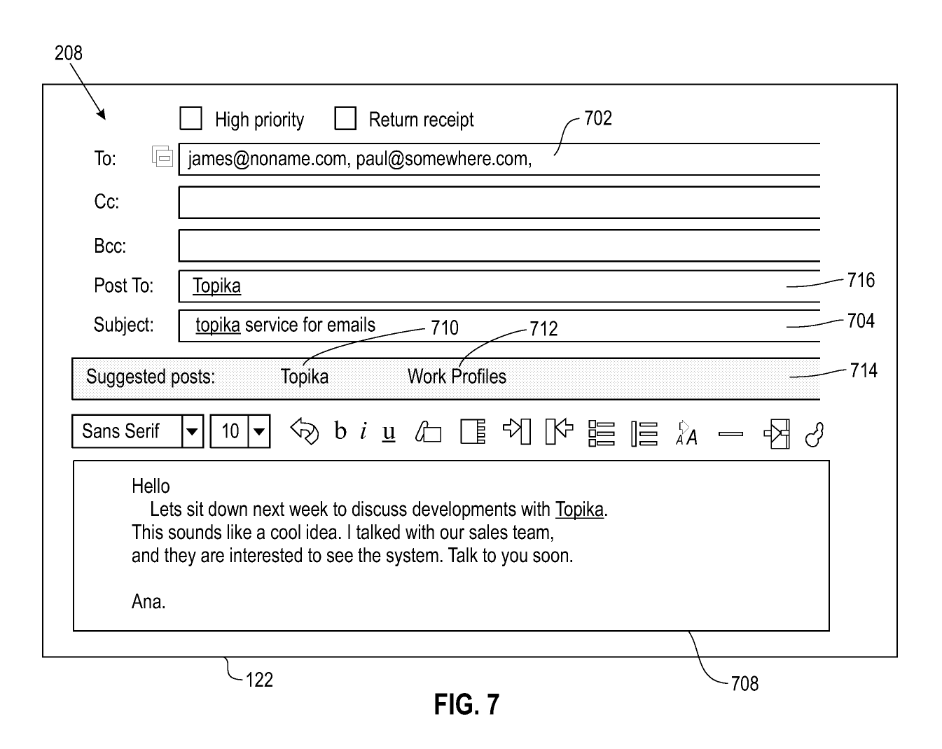

After building her work profile 116, whenever Ana uses her collaboration integrator 106 enhanced messaging client 124, it suggests one or more collaboration topics to post her emails to. FIG. 7 shows one example of the collaboration integrator interface 122 displaying a new message 208 being created by Ana via the messaging client 124. As Ana fills in the “To” field 702, “Subject” field 704, and “Body” field 706 of the message 208, the collaboration integrator 106 dynamically queries her work profile 116 with content from these fields to find the best matching work units 202. The collaboration integrator 106 then suggests the corresponding collaboration topics 710 and 712 in a portion 714 of the interface 122 and displays these suggestions as individual links or identifiers. These suggestions can be ordered according to computed relevancy. In this example, the left-most suggestion 710 is the most relevant suggestion and the right-most suggestion 712 is the least relevant suggestion, where relevance is defined in terms of the similarity between an email and a collaboration topic. Ana is then able to select one or more of the suggested collaboration topics 710 and 712. Any selected collaboration topic 710 and 712 is displayed to the user in another area of the interface 122, such as in another address field 716. In the example of FIG. 7, this address field 716 is a “Post To:” field and Ana selected the “Topika” topic 710 that was added to this field 716.

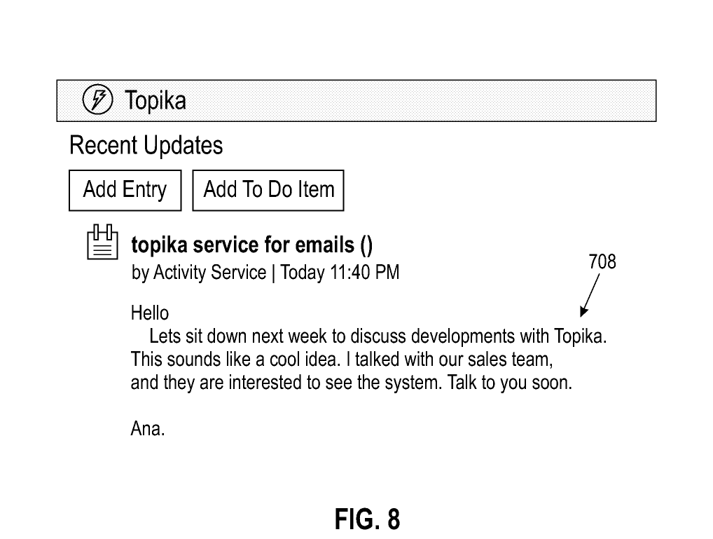

FIG. 8 shows one example of how a collaboration topic is updated based on the user sending the messaging with a collaboration topic tag in one embodiment of the present invention. Once Ana sends the message 208, the router component 114 of the collaboration integrator 106 routes or posts the message 208 to the collaboration topic(s) selected by Ana, which is the “Topika” 710 topic in this example. The message of FIG. 7 is posted to the collaboration topic “Topika” in the Activities tool 604 (in addition to the message being sent as usual to the addressees in the “To” and “CC” fields). If Ana has selected more than one collaboration topic, then the message of FIG. 7 is also routed/posted to the other topics. As shown in FIG. 8, the body 708 of the message 208 is posted to the “Topika” topic. In this embodiment, the router 114 uses an API exposed by the collaboration tools to post the email to a particular collaboration topic (identified by its unique ID) in that tool. In further embodiments, other mechanisms for posting the message to a collaboration topic are used.

In this embodiment, the router 114 has internal knowledge on how to route/post messages to the different collaborative tools. For collaborative tools 126 such as blogging or micro-blogging tools, forum discussion tools, or Lotus Activities, the routed messages can fit easily into the structure of the collaboration topics. In this situation, the messages are posted as new entries. However, other methods are also applicable, such as inserting a message within existing pages or replacing certain existing text. For some tools 126 such as wikis, messages may not easily be fitted into the structure of the collaboration topics. In this situation, various methods can be used to add the messages to the topics. For example, in a wiki an email can be appended to a special Email page in each wiki site.

The router 114 also obtains permission from the user to post information to the collaboration topics on behalf of the user. This permission can be obtained/given by the user logging into a server that passes the user's credentials to the router 114. An advantage of the interface 122 being embedded in the messaging client 124 is that the user is almost always logged into their messaging service.

Accordingly, the collaboration integrator 106 provides a lightweight mechanism for users to organize task-relevant content in collaboration tools, while continuing to use messaging clients as their predominant communication tool. The collaboration integrator 106 bridges the gap between messaging and collaboration tools, so as to allow users to contribute to these tools as a side-effect of their normal practices. The collaboration integrator 106 utilizes an efficient algorithm that determines which of the user's collaboration topics are most relevant to the message being composed. The algorithm combines different similarity metrics between an email and collaboration topic and learns the similarity weights from a labeled corpus. Additionally, the collaboration integration system can automatically summarize message email threads and archive old content. Also, message attachments can be automatically uploaded to a collaboration tool and replaced with a link to the shared copy.

Experiments were performed on the suggestion algorithm described above and the performance of this suggestion algorithm was evaluated against real email data that was hand-classified by 12 participants. In addition to showing that the algorithm performed well, the experimental data showed which attributes of both email and collaboration topics lead to the best suggestions. Additionally, the user experience with the collaboration integration system was evaluated with 32 people and two groups in the targeted user population (email users interested in or already using collaboration tools with their teams).

There were 1237 emails collected from 12 users that were all employees in a large organization and that all used both collaboration tools (including Lotus Activities and/or Lotus Wikis) and emails for their collaborative tasks.

Their work units were first extracted from the collaboration topics that they were working on (activities and wikis) using the collaboration work profile builder. Each participant was given a list of the work units in their work profiles. They were asked to label each of their approximately 100 emails with the name of one or more relevant work units. If no work units were relevant, participants did not label the email. In total, 65% of the emails were unlabeled, 24% had 1 label, 5% had 2 labels, 1.4% had 3 labels, and 4.6% had 4 to 10 labels. This dataset was divided into two parts: the training set contained 50% of emails from each user selected randomly, and the validation set contained the remaining emails.

First, the suggestion algorithm was trained using the training set to learn the weights (w₁, w₂, w₃, w₄, w₅) of individual similarity metrics using the algorithm described above. Next, the accuracy of the suggestion algorithm was evaluated using the validation set to calculate two standard metrics: recall (r) and precision (p). Recall indicates whether the right collaboration topics were suggested and measures the proportion of all user labels that the algorithm successfully suggested. Precision helps to understand how noisy the suggestions were by calculating the proportion of all suggestions made by the algorithm that were correct.

The recall and precision of the suggestion algorithm was computed for each similarity metric individually and for a combination of all similarity metrics as follows.
Recall: Let N be the total number of email and work unit pairs labeled as relevant by users, let P be the total number of email and work unit pairs that are both labeled as relevant by users and identified as relevant by the suggestion algorithm, then recall r=P/N. For example, consider Table 1 above where the total number of email and work unit pairs labeled as relevant by users is 6 (corresponding to X in 6 cells), and the total number of email and work unit pairs which are both labeled as relevant by users and identified as relevant by the suggestion algorithm is 4 (corresponding to both X and Y in 4 cells), so recall r= 4/6 or 0.67.
Precision: Let F be the total number of email and work unit pairs that were identified as relevant by the algorithm but not labeled as relevant by users (i.e., false positives), then precision p=P/(P+F). For example, using Table 1 above, the total number of email and work unit pairs not labeled as relevant by users but identified as relevant by the algorithm is 2. Thus, precision=4/(4+2)= 4/6 or 0.67.

The recall and precision results of the suggestion algorithm were compared with a baseline algorithm. The baseline algorithm made work unit suggestions for an email by computing the cosine similarity of a bag-of-words collected from the email and a bag-of-words from each work unit. For the experiments, the size of the maximum number of suggestions (K) was varied from 1 to 10. Emails in the validation set that had a higher number of labels than K were not considered. In other words, when the accuracy of the algorithm was tested where K was 2 suggestions, cases where users had labeled emails with 3 or more labels were excluded for simplicity.

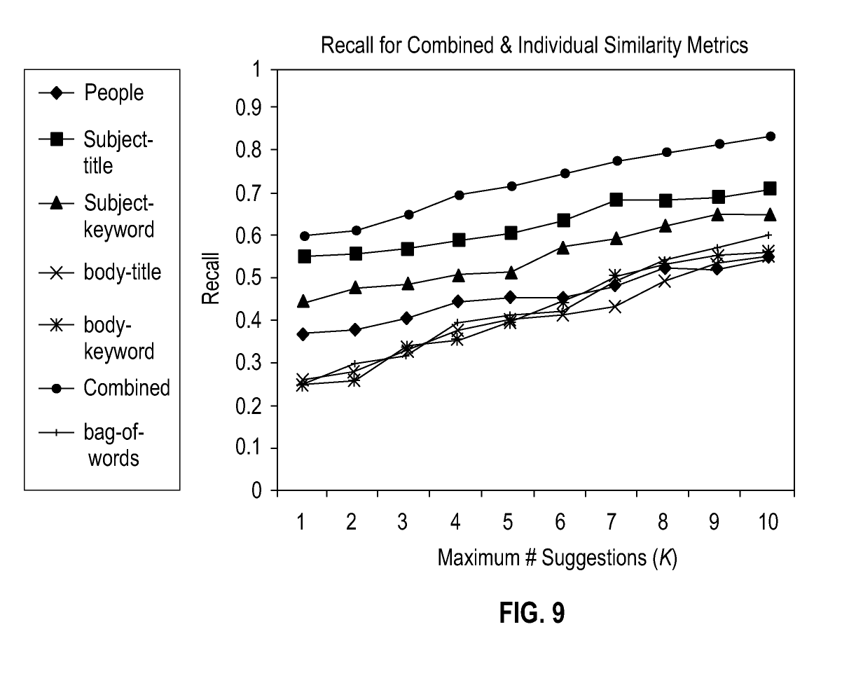

Using the recall metric (i.e., how many of the correct suggestions were generated), the suggestion algorithm performed well at suggesting the collaboration topics that matched a user's email labels. FIG. 9 shows the recall performance by similarity metric. The more suggestions given (i.e., higher values of K), the better the algorithm's recall performance across all similarity metrics. The “combined” line on the graph combining all of the similarity metrics led to significantly better suggestions than any of the individual similarity metrics (significant by a two-tailed, paired t-test, p<0.0001, 95% confidence). On average, across different values of K, combining similarity metrics led to 73% correct suggestions. Combining metrics, at least one correct suggestion is given 83% of the time and all correct suggestions are given 69% of the time.

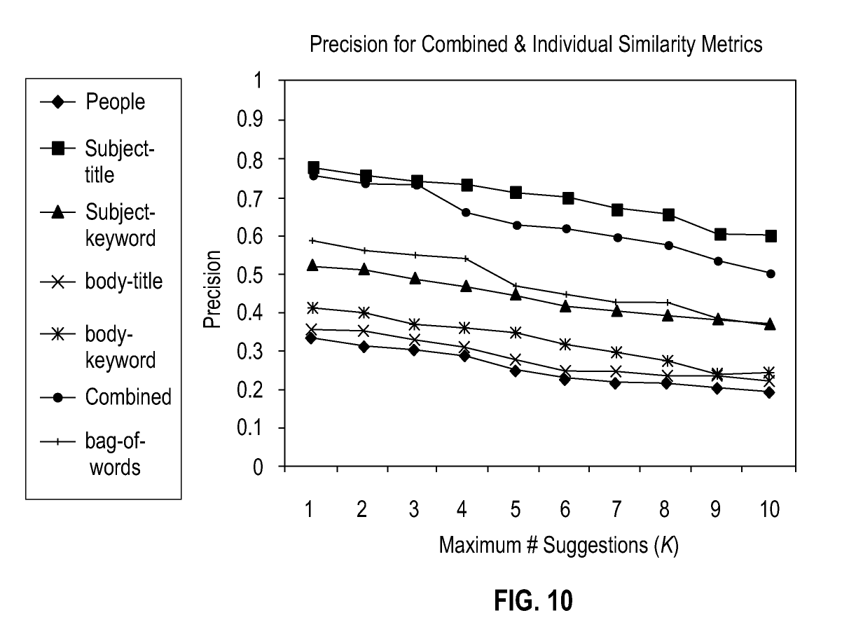

Comparing different similarity metrics, email subject and work unit title (subject-title) gave the best suggestions with 63% recall on average, one correct suggestion 78% of the time, and all correct suggestions 65% of the time, followed by email subject and work unit keywords or subject-keyword with 56% recall on average, one correct suggestion 74% of the time, and all correct suggestions 63% of the time. The suggestion algorithm also did well at precisely providing collaboration topic suggestions without many false positives. FIG. 10 shows the precision performance by similarity metric. The more suggestions given (i.e., higher values of K), the greater the incidence of false positives (i.e., the lower the precision) across all similarity metrics. The two lines on the graph for email subject and work unit title similarity (subject-title) and combining all of the similarity metrics (combined) led to significantly better precision than all of the other similarity metrics (significant by a two-tailed, paired t-test, p<0.0001, 95% confidence) and were not significantly different from each other. On average, subject-title led to 31% false positives and combined led to 37% false positives.

These experiments show that, as usual, there is a trade-off between recall and precision: as the number of suggestions increases, recall increases but precision decreases. Because users can ignore suggestions, it is better for the collaboration integrator to suggest the right collaboration topics (maximize recall) than to minimize the number of false positives (maximize precision). However, too much noise in the suggestions can lead to user annoyance. It was determined that a good balance of both high recall (75%) and precision (62%) occurs when six suggestions are shown (K=6).

The evaluation of recall/precision based on data from 12 users showed that the combined and subject-title similarity metrics both performed very well. However, it is possible that an individual user's collaboration pattern can affect the similarity metrics that lead to the best suggestions. Whether or not the best similarity metrics would be different for people with different collaboration patterns was tested by comparing the algorithm's recall and precision performance for two users: User 1 who had significant variation in the people she collaborated with across topics, and User 2 who worked with many of the same people across topics. The results of this test showed that “people” led to more accurate suggestions than any other individual similarity metric for User 1, whereas “subject-title” led to more accurate suggestions for User 2 and the aggregated set of users discussed above. As with the aggregated set of users, combined yielded the best suggestions for both cases. The precision results follow a similar pattern as for recall: “people” led to less noisy suggestions than any other individual similarity metric for the User 1, whereas “subject-title” led to less noisy suggestions for User 2. These results show that the different collaboration patterns of individual users can result in different similarity metrics being more important when deciding which collaboration topics to suggest.

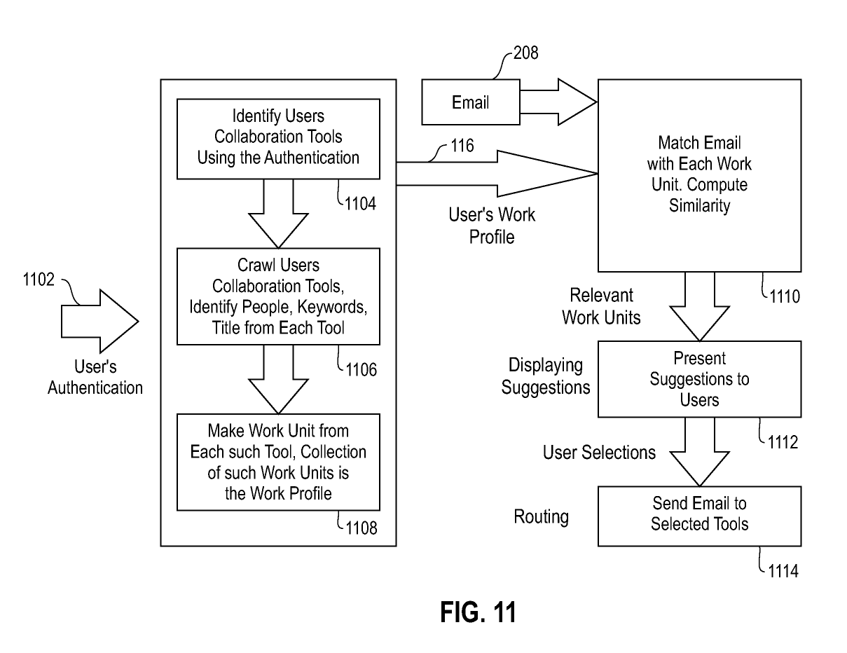

FIG. 11 is an operational flow diagram illustrating a process for integrating messaging with collaboration tools according to one embodiment of the present invention. The collaboration integrator 106 receives user authentication information, at step 1102. The collaboration integrator 106 utilizes this authentication information to identify collaboration tools 126 associated with the given user, at step 1104. The collaboration integrator 106 then analyzes each of these identified collaboration tools 126 to obtain a set of information such as people associated with the user, keywords, a title of a collaboration, and the like, at step 1106. The collaboration integrator 106 then creates a work unit 202 for each collaboration tool 126 and groups these work units 202 into a work profile 116 that is associated with the user, at step 1108.

The collaboration integrator 106 determines that the user is creating a messaging 208 using a messaging client 124 and matches/compares the message 208 to each work unit 202 in the user's work profile 116, at step 1110. The collaboration integrator 106 identifies relevant work units 202 (as a result of step 1110) and presents collaboration topic suggestions to the user via the interface 122, at step 1112. The collaboration integrator 106 receives the user's selection of one or more of the suggested collaboration topics and sends the message to the collaboration tool associated with the selected topic, at step 1114.

An example of the processes discussed above with respect to steps 1110 to 1112 is given as follows. As the user begins to compose a message, this action results in the suggestion agent 112 being called and the matcher 110 being invoked. The matcher 110 dynamically matches header and body information from the composed message with each of the work units 202 in the user's work profile 116. The matcher 110 computes the top-K relevant work units for a message, where K is the maximum number of suggestions and is set a priori. The matcher 110 returns the work unit title and the unique IDs of those top-K matched work units to the suggestion agent 112. The suggestion agent 112 displays their titles in the “suggested posts” field of the interface 122.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

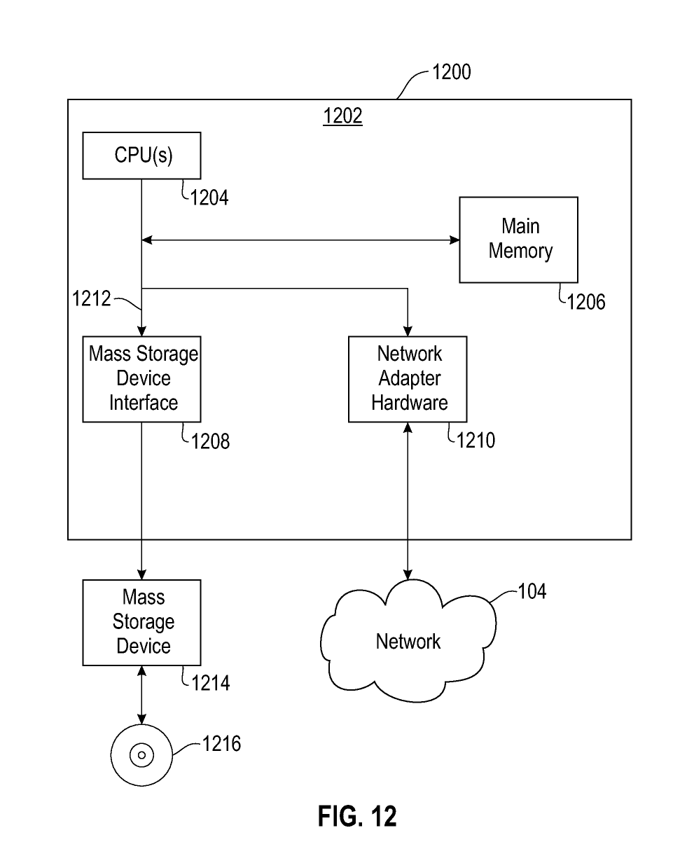

Referring now to FIG. 12, this figure is a block diagram illustrating an information processing system that can be utilized in the operating environment of FIG. 1. The information processing system 1200 is based upon a suitably configured processing system adapted to implement one or more embodiments of the present invention, such as through the server 102 or the user system 118. Similarly, any suitably configured processing system can be used as the information processing system in embodiments of the present invention.

The information processing system 1200 includes a computer 1202. The computer 1202 has a processor(s) 1204 that is connected to a main memory 1206, mass storage interface 1208, and network adapter hardware 1210. A system bus 1212 interconnects these system components. Although only one CPU 1204 is illustrated for computer 1202, computer systems with multiple CPUs can be used equally effectively. The main memory 1206, in this embodiment, comprises the collaboration integrator 106 and work profiles 116 if the system 1200 is the server system 102, or the user interface 122 and the suggestion agent 112 if the system 1200 is the user system 118.

The mass storage interface 1208 is used to connect mass storage devices, such as mass storage device 1214, to the information processing system 1200. One specific type of data storage device is an optical drive such as a CD/DVD drive, which can be used to store data to and read data from a computer readable medium or storage product such as (but not limited to) a CD/DVD 1216. Another type of data storage device is a data storage device configured to support, for example, NTFS type file system operations.

An operating system included in the main memory is a suitable multitasking operating system such as any of the Linux, UNIX, Windows, and Windows Server based operating systems. Embodiments of the present invention are also able to use any other suitable operating system. Some embodiments of the present invention utilize architectures, such as an object oriented framework mechanism, that allows instructions of the components of operating system to be executed on any processor located within the information processing system 1200. The network adapter hardware 1210 is used to provide an interface to a network 104. Embodiments of the present invention are able to be adapted to work with any data communications connections including present day analog and/or digital techniques or via a future networking mechanism.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
in response to a user creating a message in a messaging system, comparing information from the message with a plurality of data sets associated with the user, each of the data sets corresponding to a collaboration topic of the user for at least one collaboration tool;
selecting at least one of the data sets based on the comparison; and
presenting, to the user via a user interface, information indicating the one or more collaboration topics of the user that correspond to the at least one data set that is selected, the information suggesting to the user to post the message to the one or more corresponding collaboration topics of the user.

2. The method of claim 1, further comprising:
receiving, from the user, a selection of at least one of the corresponding collaboration topics of the user; and
sending the message to the at least one collaboration topic that is selected.

3. The method of claim 1, wherein the information indicating the one or more collaboration topics of the user that is presented to the user via a user interface comprises, for each of the one or more collaboration topics, at least one of an identifier for that collaboration topic and a link to that collaboration topic.

4. The method of claim 1, wherein the comparing of the information from the message with the data sets associated with the user comprises determining a similarity value for each of the data sets associated with the user, the similarity value indicating similarity between that data set and the information from the message.

5. The method of claim 4, wherein the similarity value is based on:
similarity between words in a body of the message and at least one of keywords in that data set and a title of that data set, and
similarity between a subject of the message and at least one of message descriptors in that data set, the keywords in that data set, and the title of that data set.

6. The method of claim 5, wherein the similarity of the subject of the message is weighted more than the similarity of the words in the body of the message.

7. The method of claim 5, wherein the similarity value is also based on similarity between users identified in the message and people in that data set.

8. The method of claim 1, further comprising creating a work profile for the user, the work profile comprising the data sets associated with the user.

9. The method of claim 8, wherein the creating of the work profile for the user comprises:
identifying each of the collaboration topics of the user for the at least one collaboration tool;
determining, for each of the collaboration topics that is identified, a plurality of keywords based on information within that collaboration topic; and
creating one of the data sets associated with the user for each of the collaboration topics that is identified based on the keywords that are determined for that collaboration topic.

10. A computer program product comprising a computer readable storage medium having computer readable program code embodied therewith, the computer readable program code comprising:
computer readable program code configured to:
in response to a user creating a message in a messaging system, compare information from the message with a plurality of data sets associated with the user, each of the data sets corresponding to a collaboration topic of the user for at least one collaboration tool;
select at least one of the data sets based on the comparison; and
present, to the user via a user interface, information indicating the one or more collaboration topics of the user that correspond to the at least one data set that is selected, the information suggesting to the user to post the message to the one or more corresponding collaboration topics of the user.

11. The computer program product of claim 10, wherein the computer readable program code is further configured to:
receive, from the user, a selection of at least one of the corresponding collaboration topics of the user; and
send the message to the at least one collaboration topic that is selected.

12. The computer program product of claim 10, wherein the information indicating the one or more collaboration topics of the user that is presented to the user via a user interface comprises, for each of the one or more collaboration topics, at least one of an identifier for that collaboration topic and a link to that collaboration topic.

13. The computer program product of claim 10, wherein the comparing of the information from the message with the data sets associated with the user comprises determining a similarity value for each of the data sets associated with the user, the similarity value indicating similarity between that data set and the information from the message.

14. The computer program product of claim 13, wherein the similarity value is based on:
similarity between words in a body of the message and at least one of keywords in that data set and a title of that data set, and
similarity between a subject of the message and at least one of message descriptors in that data set, the keywords in that data set, and the title of that data set.

15. The computer program product of claim 10, wherein the computer readable program code is further configured to create a work profile for the user, the work profile comprising the data sets associated with the user.

16. A system comprising:
a matcher for:
in response to a user creating a message in a messaging system, comparing information from the message with a plurality of data sets associated with the user, each of the data sets corresponding to a collaboration topic of the user for the at least one collaboration tool; and
selecting at least one of the data sets based on the comparison; and
a suggestion agent for presenting, to the user via a user interface, information indicating the one or more collaboration topics of the user that correspond to the at least one data set that is selected, the information suggesting to the user to post the message to the one or more corresponding collaboration topics of the user.

17. The system of claim 16, further comprising a router for sending the message to at least one of the corresponding collaboration topics that is selected by the user.

18. The system of claim 16, wherein the information indicating the one or more collaboration topics of the user that is presented to the user via a user interface comprises, for each of the one or more collaboration topics, at least one of an identifier for that collaboration topic and a link to that collaboration topic.

19. The system of claim 16, wherein the matcher compares the information from the message with the data sets associated with the user by determining a similarity value for each of the data sets associated with the user, the similarity value indicating similarity between that data set and the information from the message.

20. The system of claim 16, further comprising a work profile builder for creating a work profile for the user, the work profile comprising the data sets associated with the user.
